(19) United States
(12) Patent Application Publication
(10) Pub. No.: US 2019/0351779 A1
(43) Pub. Date: Nov. 21, 2019

(54) CONDUCTIVE COUPLING FOR CONTACT CHARGING AND METHOD FOR SAFE DECOUPLING

(71) Applicant: Satyajit Patwardhan, San Jose, CA (US)

(72) Inventor: Satyajit Patwardhan, San Jose, CA (US)

(73) Assignee: ConnectMyEV Inc., San Jose, CA (US)

(21) Appl. No.: 16/417,578

(22) Filed: May 20, 2019

Related U.S. Application Data
(60) Provisional application No. 62/673,803, filed on May 18, 2018.

(51) Int. Cl. B60L 53/16; H02J 7/00; H02J 7/14

(52) U.S. Cl. CPC B60L 53/16; H02J 7/0029; H02J 7/14; H02J 7/0042

(57) ABSTRACT

An apparatus, system, and method for conductive coupling for contact charging and method for safe decoupling. A first interface for transferring electrical energy to or from a mating interface. The first interface comprises a plurality of connectors coupled together. The plurality of connectors further comprises one or more of a first type of connector; and one or more of a second type of connector. In one embodiment, at least one physical property of each of at least one of the first type of connector is unequal to at least one physical property of each of at least one of the second type of connector. The first interface and the mating interface are selectively decoupleable from each other in a plurality of directions. And at least one of the first type of connector of the first interface is decoupleable from a respective mating connector in the mating interface in a different sequence than at least one of the second type of connector of the first interface is decoupleable from a respective mating connector in the mating interface.

### PROVISIONAL

This application claims priority to provisional application Ser. No. 62/673,803, filed May 18, 2018, which is incorporated by reference in its entirety.

### FIELD OF TECHNOLOGY

This disclosure relates generally to the technical fields of electrical charging, and in one example embodiment, this disclosure relates to a method, apparatus and system of safe coupling and decoupling between two interfaces.

### BACKGROUND

Charging of electric vehicles (EVs) involves a transfer of electrical energy between two interfaces. For EVs with batteries, e.g., city buses, intermittent fast charging while a bus is at a bus stop to allow ingress and egress of passengers is useful for extending the range of the bus.

However, buses might not have a consistent stopping location at a given bus stop. In addition, while the bus is stopped at the bus stop, it might have some unpredictable motion such as uncontrolled sideways motion of bus, e.g. bus tires slide on ice/snow due to passenger loading/unloading disturbances; bus is hit by another vehicle on the road; etc.

### BRIEF DESCRIPTION OF THE DRAWINGS

Example embodiments are illustrated by way of example and not limitation in the figures of the accompanying drawings, in which like references indicate similar elements and in which:

FIGS. 1-4 are prior art figures of a first interface and a second interface coupling to provide transfer of electrical energy.

FIG. 5 shows a preferred embodiment having a first interface and a second interface coupling to provide a safe transfer of electrical energy.

Other features of the present embodiments will be apparent from the accompanying drawings and from the detailed description that follows.

### DETAILED DESCRIPTION

An apparatus, system, and method for conductive coupling for contact charging and method for safe coupling and/or decoupling.

### Apparatus:

A first interface for transferring electrical energy to or from a mating interface. The first interface comprises a plurality of connectors coupled together. The plurality of connectors further comprises one or more of a first type of connector; and one or more of a second type of connector. In one embodiment, at least one physical property of each of at least one of the first type of connector is unequal to at least one physical property of each of at least one of the second type of connector. The first interface and the mating interface are selectively decoupleable from each other in a plurality of directions. And at least one of the first type of connector of the first interface is decoupleable from a respective mating connector in the mating interface in a different sequence than at least one of the second type of connector of the first interface is decoupleable from a respective mating connector in the mating interface.

In one embodiment, at least two of the plurality of connectors each have a length that is aligned in approximately a same direction; and at least one of the plurality of connectors is disposed in front of another one of the plurality of connectors in a direction of the length of the connector, and is separated by a gap.

In another embodiment, at least one physical property of each of at least two of the first type of connector is unequal to at least one physical property of each of at least two of the second type of connector. The at least one physical property is at least one of i) a size dimension, ii) a spring load, and iii) an offset from a first point of contact with the respective mating connector in different embodiments.

At least one connector of the plurality of connectors is a butt connector; and the butt connector is coupled to a spring load that forces the butt connector against a respective matting connector of the mating interface, in a first embodiment.

In another embodiment, the at least one of the first type of connector has at least one of i) a shorter dimension, ii) a lower spring loading force, and iii) an offset from an interface baseline, as compared to the at least one of the second type of connector; and the at least one of the first type of connector provides at least one of a control function and a ground function. The at least one of the second type of connector has at least one of i) a longer dimension, ii) a higher spring value, and iii) a smaller offset from a point of contact with a mating connector, as compared to the at least one connector in the first type of connector.

The first interface provides at least one function of sourcing energy and sinking energy; and the first interface is at least one of i) a pantograph on a stationary base and ii) an electrical interface on a mobile object.

In one embodiment, all the plurality of connectors with the first type of connector each have at least one of i) a shorter dimension, ii) a lower spring loading force, and iii) a larger offset from a point of contact with a respective mating connector, as compared to the at least one connector of the second type of connector; and the plurality of connectors with the first type of connector together provide at least one of a control function and a ground function.

In another embodiment, a first interface for transferring electrical energy with a mating interface, the first interface comprising: a plurality of connectors coupled together, where the plurality of connectors further comprise a first type of connector; and a second type of connector. In this embodiment, a physical property of at least two connectors with the first type of connectors is different from a physical property of at least two connectors with the second type of connectors; and the first type of connector and the second type of connector are not restricted from movement in more than one direction by respective mating connectors on the mating interface.

### System:

In one embodiment an electrical interface system for transferring electrical energy comprises i) a first interface comprising a plurality of connectors that further comprise both a first type of connector and a second type of connector; and ii) a mating interface comprising a plurality of respective mating connectors to the first interface. At least one of the plurality of connectors of both the first and mating interface transfer energy therebetween. In this first embodiment, the first interface and the mating interface are selectively decoupleable from each other in a plurality of directions; and at least one of the first type of connector of the first interface is decoupleable from a respective mating connector in the mating interface in a different sequence than at least one of the second type of connector of the first interface is decoupleable from a respective mating connector in the mating interface.

In other embodiment, a physical property of at least one connector in the first type of connectors is different from a physical property of at least one connector in the second type of connectors in order to provide safe coupling or decoupling sequencing.

An axis along a length of at least one connector in the first interface is approximately non-parallel to an axis along a length of at least one connector in the mating interface in another embodiment. In yet another embodiment, the length of at least one connector in the first type of connectors is shorter than a length of at least one connector in the second type of connectors. Another embodiment has an axis along a length of at least one connector in the first interface is approximately orthogonal to an axis along a length of at least one connector in the mating interface.

At least one physical property of each of at least two of the first type of connector is unequal to at least one physical property of each of at least two of the second type of connector, as described above for the apparatus.

The first interface and the mating interface are selectively decoupleable by moving the first interface or the mating interface in at least one of three dimensions. Furthermore, the different sequence for disengaging can occur in a plurality of directions in one embodiment. In another embodiment, the plurality of mating connectors in the mating interface further comprises at least one of the first type of connector and at least one of the second type of connector. The first type of connector in the first interface mates respectively with the first type of connector in the mating interface, in order to provide the different sequence of selectively decoupling in a plurality of directions.

### EXAMPLES PROVIDED IN FIGURES

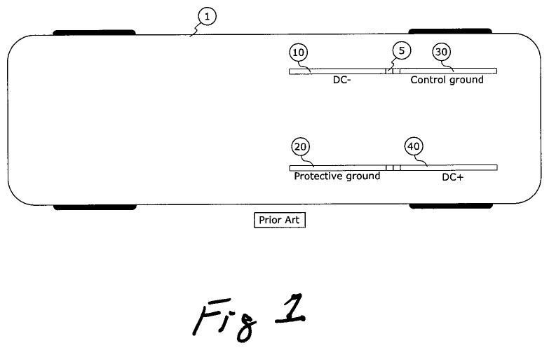

FIG. 1: Prior Art: Traditional scheme of charging a transportation-bus (1). Four electrical-bus bars 10, 20, 30 and 40 are mounted on the roof of a transportation-bus 1. The function of each of the electrical-bus bars 10, 20, 30 and 40 is DC−, protective ground, control ground, DC+ respectively. The four electrical-bus bars are separated using insulating spacers 5. DC+ and DC− supply the high voltage and high current required to charge transportation-bus batteries. Protective ground connects the vehicle to nearby buried ground pole for protection. Control ground communicates charger's current capacity and provides way of checking ground connectivity. When any of the Protective Ground and Control Pilot are disconnected, charging equipment (infrastructure) is designed to disconnect main charging power (positive and negative poles are de-energized).

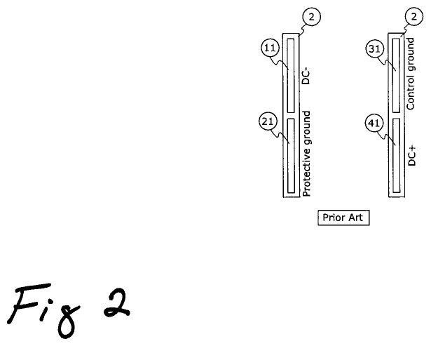

FIG. 2: Prior Art: An overhead pantograph 2 is deployed downward to meet vehicle mounted rails. The pantograph also has four electrical-bus bars 11, 21, 31 and 41. The function of each of the electrical-bus bars 11, 21, 31 and 41 is DC−, protective ground, control ground, DC+ respectively.

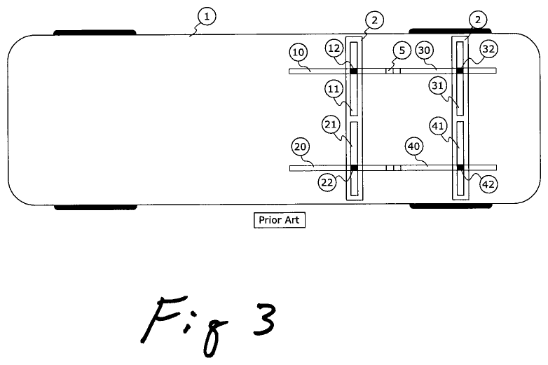

FIG. 3: Prior Art: When the pantograph 2 meets the rails on bus 1, a charging connection is established through the overlap regions 12, 22, 32 and 42 established between the electrical-bus bar pairs 10-11, 20-21, 30-31 and 40-41 respectively.

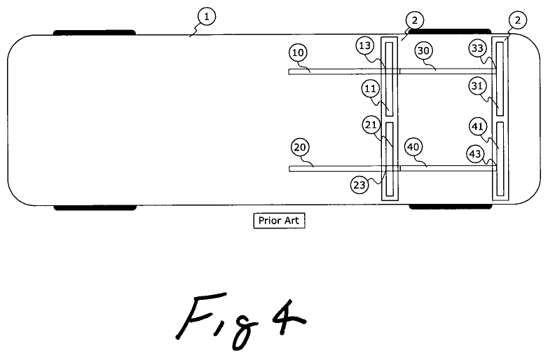

FIG. 4: Prior Art Problem: When the transportation-bus 1 moves with respect to the pantograph 2, at some point all four electrical-bus bar pairs 10-11, 20-21, 30-31 and 40-41 disconnect from each other, thus creating gaps 12, 22, 32 and 42 respectively. Since all bus bars disconnect from each other simultaneously, the protective circuit triggered by control ground and protective ground disconnection does not have enough time fully disconnect the charging power, and a result the there is a strong possibility of an electrical arc at the gaps 12 and 42.

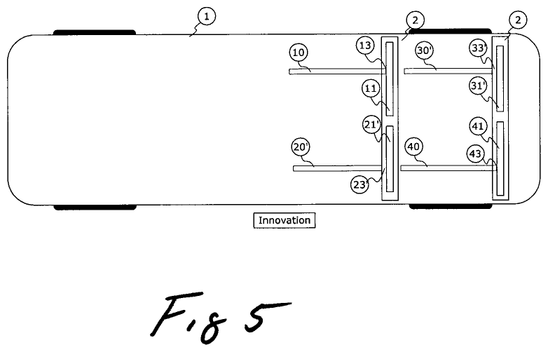

FIG. 5: Innovation presented in this invention is to shorten the electrical bus bars 20, 30, 21 and 31, shown here as 20′, 30′, 21′, 31′ respectively. In this arrangement, when the bus bars 10 and 11 or bus bars 40 and 41 are separating, the gaps 22′ and 32′ are already well established and hence the protective circuits connected to protective ground and control ground would have already turned off the charging power. Thus eliminating the possibility of any electrical arc.

### Method:

One embodiment of a method of controlling a transfer of electrical energy between a first interface and a mating interface that comprises engaging the first interface comprising a plurality of connectors, with the mating interface comprising a respective plurality of mating connectors; transferring electrical energy between the first interface and the mating interface; disengaging at least one of a first type of connector of the plurality of connectors on the first interface from a respective at least one mating connector on the mating interface; and disengaging at least one of a second type of connector of the plurality of connectors on the first interface from a respective at least one mating connector on the mating interface. The operation of disengaging the first type of connector occurs in a different sequence than the operation of disengaging the second type of connector, in the present embodiment, wherein the operation of disengaging can occur in a plurality of directions.

The respective mating connector on the mating interface is a first type of connector for the first type of connector on the first interface, in one embodiment, and the respective mating connector on the mating interface is a second type of connector for the second type of connector on the first interface in another embodiment. The operation of disengaging occurs in different sequences for each of at least two of the plurality of directions for a present embodiment.

A physical property of the at least one connector in the first type of connectors is different from a physical property of the at least one connector in the second type of connectors in order to provide a safe decoupleable sequencing, in the present embodiment.

Orienting an axis along a length of at least one connector disposed on the first interface non-parallelly to an axis along a length of at least one connector disposed on the mating interface. In another embodiment, at least one of the first type of connector of the plurality of connectors on the first interface is butt connected with a respective at least one mating connector of the plurality of connectors on the mating interface.

A next operation is setting for a first type of connector of the first interface at least one of a force load and an offset from a point of contact with a respective mating connector on the mating interface, and setting for a second type of connector of the first interface at least one of a force load and an offset from a point of contact with a respective mating connector on the mating interface, wherein the setting for the first type of connector is not required to be the same as from the setting for the second type of connector.

In one embodiment, a method to ensure that the conductors (+, −, G and CP) always engage and disengage in a particular sequence is called “Contact sequencing”. This disclosure teaches a geometric method to ensure that either G or CP or both are always the first to disengage (or last the engage) during sideways movement of the vehicle. Thus protecting against possibility of electrical

### Alternatives

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph six, interpretation for that unit/circuit/component.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

I claim:

1. An interface for transfer of electrical power, comprising;
a destination interface comprising a first connector and a second connector; and
a source interface comprising a third connector and fourth connector;
wherein the first connector is configured to move relative to the third connector and the second connector is configured to move relative to a fourth connector, and
wherein the second connector is selectively decoupled from the fourth connector while connection is maintained between the first connector and the second connector.

2. The interface of claim 1, wherein the first connector and the third connector transfer electrical power between them.

3. The interface of claim 1, wherein the third connector and the fourth connector are part of a ground circuit.

4. The interface of claim 1, wherein the third connector and the fourth connector are part of a control circuit.

5. The interface of claim 1, wherein the destination interface is stationary relative to the source interface.

6. The interface of claim 1, wherein the source interface is stationary relative to the destination interface.

7. The interface of claim 6, wherein the destination interface is a portion of a vehicle.

8. The interface of claim 7, wherein the first connector is positioned on a roof of the vehicle.

9. A system for conveying electricity between a first interface and a second interface, wherein coupling and decoupling of the first and second interfaces is subject to s, y, and yaw displacements, comprising:
each of the first and second interfaces has an elongated ground connector, an elongated control connector, an elongated first power connector, and an elongated second power connector;
each of the connectors of the first and second interfaces sized and dimensioned such that regardless of relative orientations of the first and second interfaces, the first and second power connectors of the first interface are always coupled with the first and second power connectors of the second interface prior to coupling if the of the ground and control connectors of the first interface with the ground and control connectors of the second interface.

10. The system of claim 9, wherein when the first and second power connectors of the first interface are mated with the first and second power connectors of the second interface, the first power connector of the first interface are with 30° of perpendicular to the first power connector of the second interface.

11. The system of claim 9, wherein in the first interface, the first and second power connectors are butt connectors.

12. The system of claim 9, wherein in the first interface, the ground connector is parallel to the control connector.

13. The system of claim 9, wherein in the first interface, the first power connector is parallel to the second power connector.

14. The system of claim 9, wherein in the first interface, the first power connector is longer than the control connector.

15. The system of claim 9, wherein in the first interface, the first power connector is longer than the ground connector.

16. The system of claim 9, wherein in the first interface, the first power connector is longer than both the control connector and the ground connector.

17. The system of claim 9, wherein in the first interface each of the ground connector, the control connector, and the first and second power connectors have mating surfaces that are substantially co-planar.

18. The system of claim 9, wherein in the first interface each of the ground connector, the control connector, and the first and second power connectors have mating surfaces that are substantially co-planar.
